(19) United States
(12) Patent Application Publication
(10) Pub. No.: US 2015/0195326 A1
(43) Pub. Date: Jul. 9, 2015

(54) DETECTING WHETHER HEADER COMPRESSION IS BEING USED FOR A FIRST STREAM BASED UPON A DELAY DISPARITY BETWEEN THE FIRST STREAM AND A SECOND STREAM

(71) Applicant: QUALCOMM Incorporated, San Diego, CA (US)

(72) Inventors: Vijay SURYAVANSHI, San Diego, CA (US); Giridhar Dhati MANDYAM, San Diego, CA (US); Mark MAGGENTI, Del Mar, CA (US)

(73) Assignee: QUALCOMM Incorporated, San Diego, CA (US)

(21) Appl. No.: 14/147,283

(22) Filed: Jan. 3, 2014

(51) Int. Cl. H04L 29/06

(52) U.S. Cl. CPC H04L 65/608

(57) ABSTRACT

In an embodiment, a target device (e.g., a server or a target client device) receives a first stream (e.g., an RTP stream) and a second stream (e.g., a probing stream) for a given communication session that originates from an application-layer client application on a source client device. The target device calculates delays of arrival times for packet payload portions in the first and second streams, and reports information indicative of a delay disparity between the first and second delays to the application-layer client application on the source client device. The application-layer client application on the source client device determines whether header compression of a given type is used for the first stream based on the received information, and selectively modifies one or more parameters (e.g., a bundling factor, etc.) of the first stream based on the determination.

### BACKGROUND OF THE INVENTION

1. Field of the Invention

Embodiments of the invention relate to detecting whether header compression is being used for a first stream based upon a delay disparity between the first stream and a second stream.

2. Description of the Related Art

Wireless communication systems have developed through various generations, including a first-generation analog wireless phone service (1G), a second-generation (2G) digital wireless phone service (including interim 2.5G and 2.75G networks) and third-generation (3G) and fourth-generation (4G) high speed data/Internet-capable wireless services. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

More recently, Long Term Evolution (LTE) has been developed as a wireless communications protocol for wireless communication of high-speed data for mobile phones and other data terminals. LTE is based on GSM, and includes contributions from various GSM-related protocols such as Enhanced Data rates for GSM Evolution (EDGE), and Universal Mobile Telecommunications System (UMTS) protocols such as High-Speed Packet Access (HSPA).

In typical client device implementations, application-layer client applications (e.g., mobile web browsers operating in accordance with WebRTC, VoIP applications managing one or more VoIP sessions, etc.) are not aware of whether their packets are allocated header compression (e.g., such as Robust Header Compression (RoHC)) at lower layers (e.g., transport and/or physical layers) of a user equipment (UE). Instead, the application-layer client applications will simply exchange a stream of packets to/from the lower layers without knowing whether header compression is being used to send/receive the stream of packets between the lower layers of the UE and one or more external entities (e.g., such as a base station or eNodeB).

### SUMMARY

In an embodiment, a target device (e.g., a server or a target client device) receives a first stream (e.g., an RTP stream) and a second stream (e.g., a probing stream) for a given communication session that originates from an application-layer client application on a source client device. The target device calculates delays of arrival times for packet payload portions in the first and second streams, and reports information indicative of a delay disparity between the first and second delays to the application-layer client application on the source client device. The application-layer client application on the source client device determines whether header compression of a given type is used for the first stream based on the received information, and selectively modifies one or more parameters (e.g., a bundling factor, etc.) of the first stream based on the determination.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 illustrates a high-level system architecture of a wireless communications system in accordance with an embodiment of the invention.

FIG. 2A illustrates an example configuration of a radio access network (RAN) and a packet-switched portion of a core network for a 1x EV-DO network in accordance with an embodiment of the invention.

FIG. 2B illustrates an example configuration of the RAN and a packet-switched portion of a General Packet Radio Service (GPRS) core network within a 3G UMTS W-CDMA system in accordance with an embodiment of the invention.

FIG. 2C illustrates another example configuration of the RAN and a packet-switched portion of a GPRS core network within a 3G UMTS W-CDMA system in accordance with an embodiment of the invention.

FIG. 2D illustrates an example configuration of the RAN and a packet-switched portion of the core network that is based on an Evolved Packet System (EPS) or Long Term Evolution (LTE) network in accordance with an embodiment of the invention.

FIG. 2E illustrates an example configuration of an enhanced High Rate Packet Data (HRPD) RAN connected to an EPS or LTE network and also a packet-switched portion of an HRPD core network in accordance with an embodiment of the invention.

FIG. 3 illustrates examples of user equipments (UEs) in accordance with embodiments of the invention.

FIG. 4 illustrates a communication device that includes logic configured to perform functionality in accordance with an embodiment of the invention.

FIG. 5 illustrates a server in accordance with an embodiment of the invention.

FIG. 6 illustrates another UE in accordance with an embodiment of the invention.

FIG. 7 illustrates a process by which an application-layer client application determines whether one of its streams is using header compression in accordance with an embodiment of the invention.

FIG. 8 relates to an example implementation of FIG. 7 whereby a target device is an application server in accordance with an embodiment of the present invention

FIG. 9A illustrates an example configuration of a Realtime Transport Protocol (RTP) packet in an RTP stream in accordance with an embodiment of the present invention.

FIG. 9B illustrates an example configuration of a probing packet in a probing stream in accordance with an embodiment of the present invention.

FIG. 10 relates to an example implementation of FIG. 7 whereby the target device is a target UE in accordance with an embodiment of the present invention

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A client device, referred to herein as a user equipment (UE), may be mobile or stationary, and may communicate with a radio access network (RAN). As used herein, the term “UE” may be referred to interchangeably as an “access terminal” or “AT”, a “wireless device”, a “subscriber device”, a “subscriber terminal”, a “subscriber station”, a “user terminal” or UT, a “mobile terminal”, a “mobile station” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

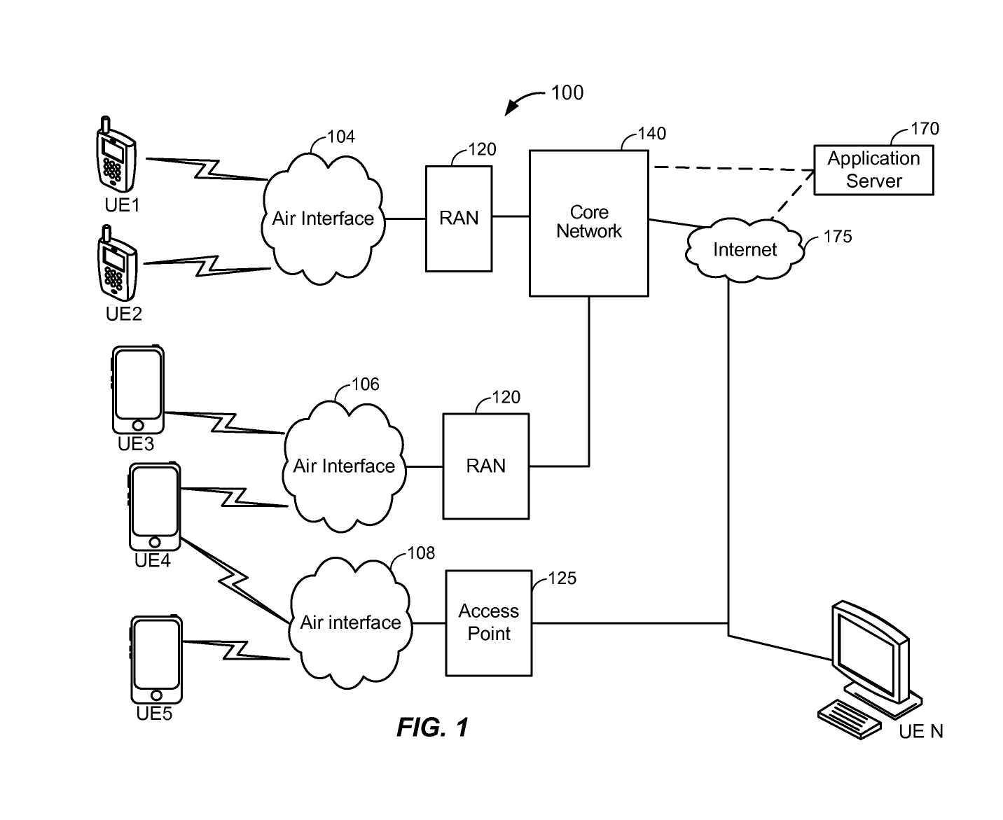

FIG. 1 illustrates a high-level system architecture of a wireless communications system 100 in accordance with an embodiment of the invention. The wireless communications system 100 contains UEs 1 . . . N. The UEs 1 . . . N can include cellular telephones, personal digital assistant (PDAs), pagers, a laptop computer, a desktop computer, and so on. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., the RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 includes a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UE N and UEs 1 . . . N via the core network 140. Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, an application server 170 is shown as connected to the Internet 175, the core network 140, or both. The application server 170 can be implemented as a plurality of structurally separate servers, or alternately may correspond to a single server. As will be described below in more detail, the application server 170 is configured to support one or more communication services (e.g., Voice-over-Internet Protocol (VoIP) sessions, Push-to-Talk (PTT) sessions, group communication sessions, social networking services, etc.) for UEs that can connect to the application server 170 via the core network 140 and/or the Internet 175.

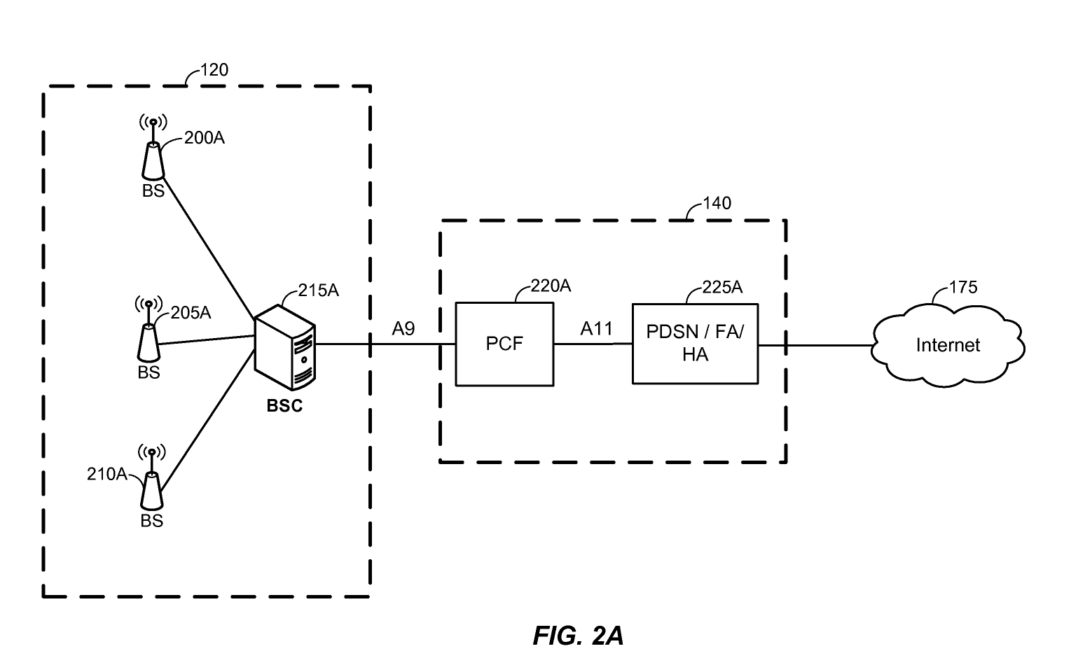

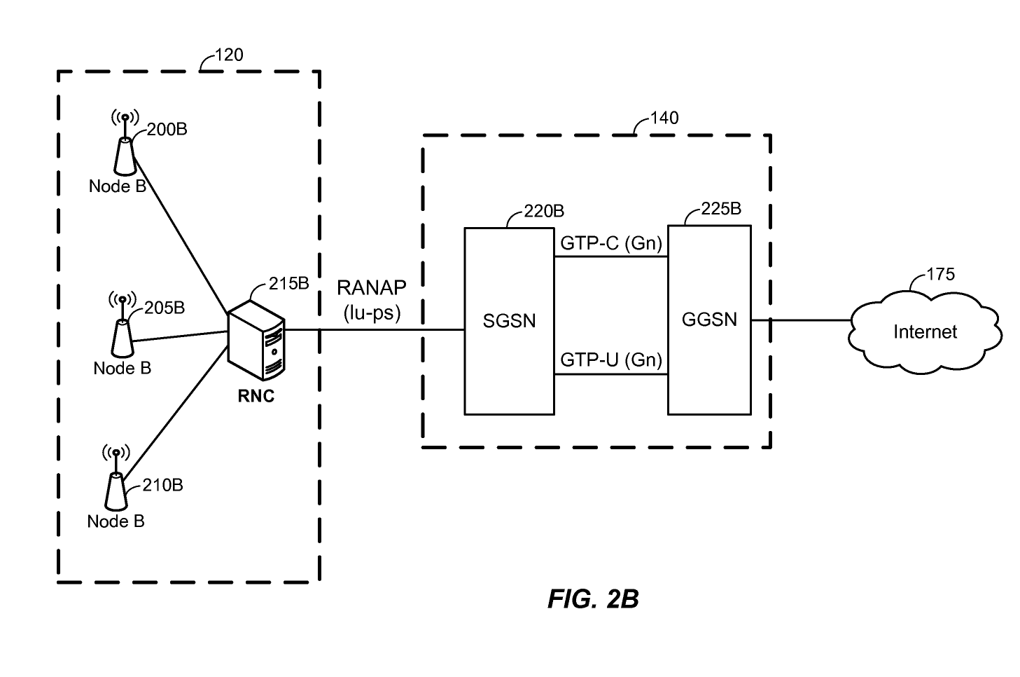

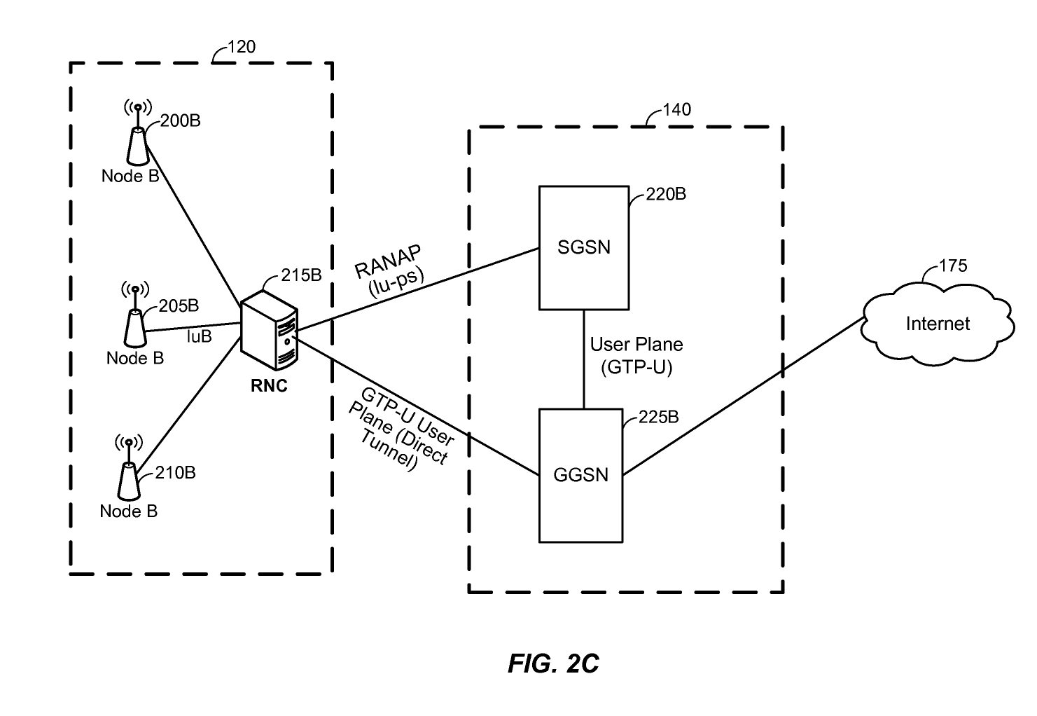

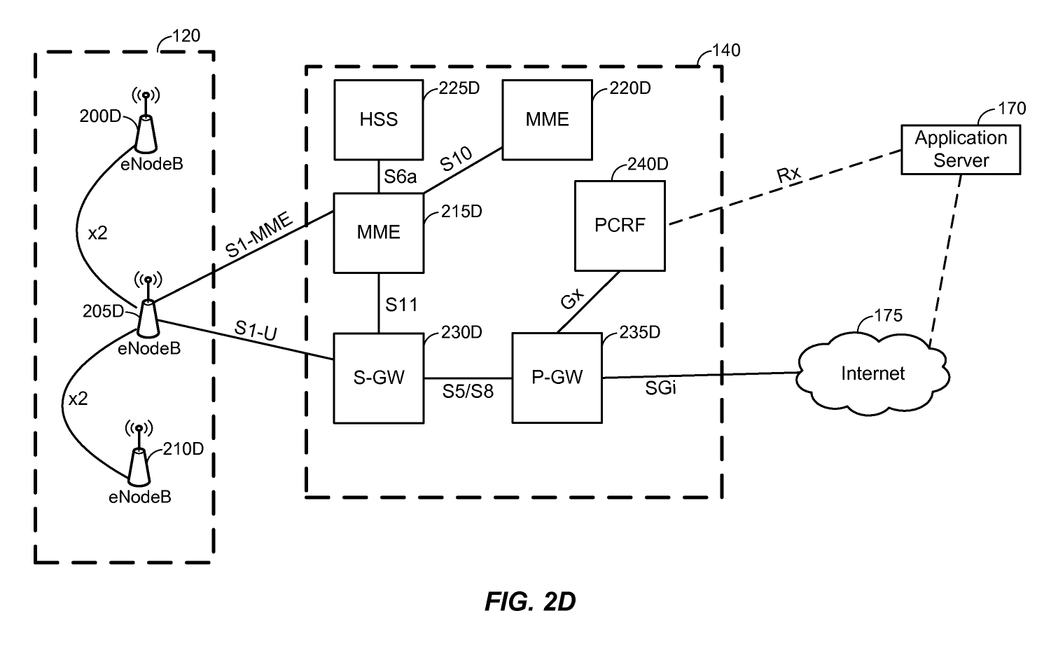

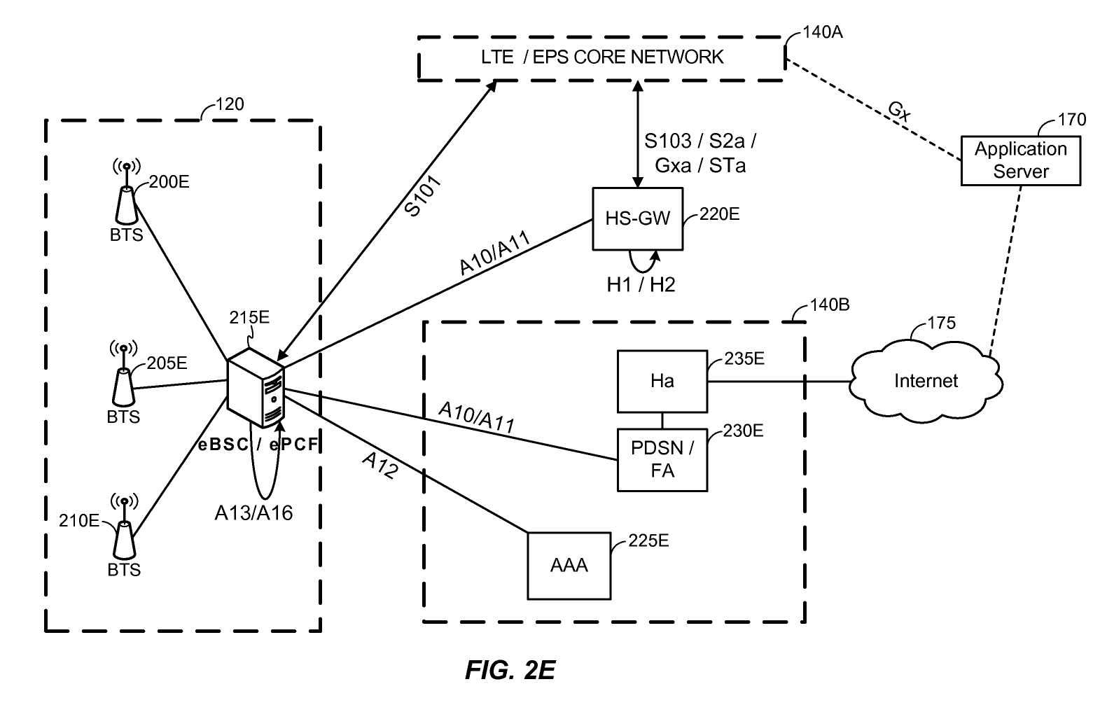

Examples of protocol-specific implementations for the RAN 120 and the core network 140 are provided below with respect to FIGS. 2A through 2D to help explain the wireless communications system 100 in more detail. In particular, the components of the RAN 120 and the core network 140 corresponds to components associated with supporting packet-switched (PS) communications, whereby legacy circuit-switched (CS) components may also be present in these networks, but any legacy CS-specific components are not shown explicitly in FIGS. 2A-2D.

FIG. 2A illustrates an example configuration of the RAN 120 and the core network 140 for packet-switched communications in a CDMA2000 1x Evolution-Data Optimized (EV-DO) network in accordance with an embodiment of the invention. Referring to FIG. 2A, the RAN 120 includes a plurality of base stations (BSs) 200A, 205A and 210A that are coupled to a base station controller (BSC) 215A over a wired backhaul interface. A group of BSs controlled by a single BSC is collectively referred to as a subnet. As will be appreciated by one of ordinary skill in the art, the RAN 120 can include multiple BSCs and subnets, and a single BSC is shown in FIG. 2A for the sake of convenience. The BSC 215A communicates with a packet control function (PCF) 220A within the core network 140 over an A9 connection. The PCF 220A performs certain processing functions for the BSC 215A related to packet data. The PCF 220A communicates with a Packet Data Serving Node (PDSN) 225A within the core network 140 over an A11 connection. The PDSN 225A has a variety of functions, including managing Point-to-Point (PPP) sessions, acting as a home agent (HA) and/or foreign agent (FA), and is similar in function to a Gateway General Packet Radio Service (GPRS) Support Node (GGSN) in GSM and UMTS networks (described below in more detail). The PDSN 225A connects the core network 140 to external IP networks, such as the Internet 175.

FIG. 2B illustrates an example configuration of the RAN 120 and a packet-switched portion of the core network 140 that is configured as a GPRS core network within a 3G UMTS W-CDMA system in accordance with an embodiment of the invention. Referring to FIG. 2B, the RAN 120 includes a plurality of Node Bs 200B, 205B and 210B that are coupled to a Radio Network Controller (RNC) 215B over a wired backhaul interface. Similar to 1x EV-DO networks, a group of Node Bs controlled by a single RNC is collectively referred to as a subnet. As will be appreciated by one of ordinary skill in the art, the RAN 120 can include multiple RNCs and subnets, and a single RNC is shown in FIG. 2B for the sake of convenience. The RNC 215B is responsible for signaling, establishing and tearing down bearer channels (i.e., data channels) between a Serving GRPS Support Node (SGSN) 220B in the core network 140 and UEs served by the RAN 120. If link layer encryption is enabled, the RNC 215B also encrypts the content before forwarding it to the RAN 120 for transmission over an air interface. The function of the RNC 215B is well-known in the art and will not be discussed further for the sake of brevity.

In FIG. 2B, the core network 140 includes the above-noted SGSN 220B (and potentially a number of other SGSNs as well) and a GGSN 225B. Generally, GPRS is a protocol used in GSM for routing IP packets. The GPRS core network (e.g., the GGSN 225B and one or more SGSNs 220B) is the centralized part of the GPRS system and also provides support for W-CDMA based 3G access networks. The GPRS core network is an integrated part of the GSM core network (i.e., the core network 140) that provides mobility management, session management and transport for IP packet services in GSM and W-CDMA networks.

The GPRS Tunneling Protocol (GTP) is the defining IP protocol of the GPRS core network. The GTP is the protocol which allows end users (e.g., UEs) of a GSM or W-CDMA network to move from place to place while continuing to connect to the Internet 175 as if from one location at the GGSN 225B. This is achieved by transferring the respective UE's data from the UE's current SGSN 220B to the GGSN 225B, which is handling the respective UE's session.

Three forms of GTP are used by the GPRS core network; namely, (i) GTP-U, (ii) GTP-C and (iii) GTP′ (GTP Prime). GTP-U is used for transfer of user data in separated tunnels for each packet data protocol (PDP) context. GTP-C is used for control signaling (e.g., setup and deletion of PDP contexts, verification of GSN reach-ability, updates or modifications such as when a subscriber moves from one SGSN to another, etc.). GTP′ is used for transfer of charging data from GSNs to a charging function.

Referring to FIG. 2B, the GGSN 225B acts as an interface between a GPRS backbone network (not shown) and the Internet 175. The GGSN 225B extracts packet data with associated a packet data protocol (PDP) format (e.g., IP or PPP) from GPRS packets coming from the SGSN 220B, and sends the packets out on a corresponding packet data network. In the other direction, the incoming data packets are directed by the GGSN connected UE to the SGSN 220B which manages and controls the Radio Access Bearer (RAB) of a target UE served by the RAN 120. Thereby, the GGSN 225B stores the current SGSN address of the target UE and its associated profile in a location register (e.g., within a PDP context). The GGSN 225B is responsible for IP address assignment and is the default router for a connected UE. The GGSN 225B also performs authentication and charging functions.

The SGSN 220B is representative of one of many SGSNs within the core network 140, in an example. Each SGSN is responsible for the delivery of data packets from and to the UEs within an associated geographical service area. The tasks of the SGSN 220B includes packet routing and transfer, mobility management (e.g., attach/detach and location management), logical link management, and authentication and charging functions. The location register of the SGSN 220B stores location information (e.g., current cell, current VLR) and user profiles (e.g., IMSI, PDP address(es) used in the packet data network) of all GPRS users registered with the SGSN 220B, for example, within one or more PDP contexts for each user or UE. Thus, SGSNs 220B are responsible for (i) de-tunneling downlink GTP packets from the GGSN 225B, (ii) uplink tunnel IP packets toward the GGSN 225B, (iii) carrying out mobility management as UEs move between SGSN service areas and (iv) billing mobile subscribers. As will be appreciated by one of ordinary skill in the art, aside from (i)-(iv), SGSNs configured for GSM/EDGE networks have slightly different functionality as compared to SGSNs configured for W-CDMA networks.

The RAN 120 (e.g., or UTRAN, in UMTS system architecture) communicates with the SGSN 220B via a Radio Access Network Application Part (RANAP) protocol. RANAP operates over a Iu interface (Iu-ps), with a transmission protocol such as Frame Relay or IP. The SGSN 220B communicates with the GGSN 225B via a Gn interface, which is an IP-based interface between SGSN 220B and other SGSNs (not shown) and internal GGSNs (not shown), and uses the GTP protocol defined above (e.g., GTP-U, GTP-C, GTP′, etc.). In the embodiment of FIG. 2B, the Gn between the SGSN 220B and the GGSN 225B carries both the GTP-C and the GTP-U. While not shown in FIG. 2B, the Gn interface is also used by the Domain Name System (DNS). The GGSN 225B is connected to a Public Data Network (PDN) (not shown), and in turn to the Internet 175, via a Gi interface with IP protocols either directly or through a Wireless Application Protocol (WAP) gateway.

FIG. 2C illustrates another example configuration of the RAN 120 and a packet-switched portion of the core network 140 that is configured as a GPRS core network within a 3G UMTS W-CDMA system in accordance with an embodiment of the invention. Similar to FIG. 2B, the core network 140 includes the SGSN 220B and the GGSN 225B. However, in FIG. 2C, Direct Tunnel is an optional function in Iu mode that allows the SGSN 220B to establish a direct user plane tunnel, GTP-U, between the RAN 120 and the GGSN 225B within a PS domain. A Direct Tunnel capable SGSN, such as SGSN 220B in FIG. 2C, can be configured on a per GGSN and per RNC basis whether or not the SGSN 220B can use a direct user plane connection. The SGSN 220B in FIG. 2C handles the control plane signaling and makes the decision of when to establish Direct Tunnel. When the RAB assigned for a PDP context is released (i.e. the PDP context is preserved) the GTP-U tunnel is established between the GGSN 225B and SGSN 220B in order to be able to handle the downlink packets.

FIG. 2D illustrates an example configuration of the RAN 120 and a packet-switched portion of the core network 140 based on an Evolved Packet System (EPS) or LTE network, in accordance with an embodiment of the invention. Referring to FIG. 2D, unlike the RAN 120 shown in FIGS. 2B-2C, the RAN 120 in the EPS/LTE network is configured with a plurality of Evolved Node Bs (ENodeBs or eNBs) 200D, 205D and 210D, without the RNC 215B from FIGS. 2B-2C. This is because ENodeBs in EPS/LTE networks do not require a separate controller (i.e., the RNC 215B) within the RAN 120 to communicate with the core network 140. In other words, some of the functionality of the RNC 215B from FIGS. 2B-2C is built into each respective eNodeB of the RAN 120 in FIG. 2D.

In FIG. 2D, the core network 140 includes a plurality of Mobility Management Entities (MMES) 215D and 220D, a Home Subscriber Server (HSS) 225D, a Serving Gateway (S-GW) 230D, a Packet Data Network Gateway (P-GW) 235D and a Policy and Charging Rules Function (PCRF) 240D. Network interfaces between these components, the RAN 120 and the Internet 175 are illustrated in FIG. 2D and are defined in Table 1 (below) as follows:

TABLE 1
EPS/LTE Core Network Connection Definitions

| Network Interface | Description |
|---|---|
| S1-MME | Reference point for the control plane protocol between RAN 120 and |
| | MME 215D. |
| S1-U | Reference point between RAN 120 and S-GW 230D for the per |
| | bearer user plane tunneling and inter-eNodeB path switching during |
| | handover. |
| S5 | Provides user plane tunneling and tunnel management between S- |
| | GW 230D and P-GW 235D. It is used for S-GW relocation due to |
| | UE mobility and if the S-GW 230D needs to connect to a non- |
| | collocated P-GW for the required PDN connectivity. |
| S6a | Enables transfer of subscription and authentication data for |
| | authenticating/authorizing user access to the evolved system |
| | (Authentication, Authorization, and Accounting [AAA] interface) |
| | between MME 215D and HSS 225D. |
| Gx | Provides transfer of Quality of Service (QoS) policy and charging |
| | rules from PCRF 240D to Policy a Charging Enforcement Function |
| | (PCEF) component (not shown) in the P-GW 235D. |
| S8 | Inter-PLMN reference point providing user and control plane |
| | between the S-GW 230D in a Visited Public Land Mobile Network |
| | (VPLMN) and the P-GW 235D in a Home Public Land Mobile |
| | Network (HPLMN). S8 is the inter-PLMN variant of S5. |
| S10 | Reference point between MMEs 215D and 220D for MME |
| | relocation and MME to MME information transfer. |
| S11 | Reference point between MME 215D and S-GW 230D. |
| SGi | Reference point between the P-GW 235D and the packet data |
| | network, shown in FIG. 2D as the Internet 175. The Packet data |
| | network may be an operator external public or private packet data |
| | network or an intra-operator packet data network (e.g., for provision |
| | of IMS services). This reference point corresponds to Gi for 3GPP |
| | accesses. |
| X2 | Reference point between two different eNodeBs used for UE |
| | handoffs. |
| Rx | Reference point between the PCRF 240D and an application function |
| | (AF) that is used to exchanged application-level session information, |
| | where the AF is represented in FIG. 1 by the application server 170. |

A high-level description of the components shown in the RAN 120 and core network 140 of FIG. 2D will now be described. However, these components are each well-known in the art from various 3GPP TS standards, and the description contained herein is not intended to be an exhaustive description of all functionalities performed by these components.

Referring to FIG. 2D, the MMEs 215D and 220D are configured to manage the control plane signaling for the EPS bearers. MME functions include: Non-Access Stratum (NAS) signaling, NAS signaling security, Mobility management for inter- and intra-technology handovers, P-GW and S-GW selection, and MME selection for handovers with MME change.

Referring to FIG. 2D, the S-GW 230D is the gateway that terminates the interface toward the RAN 120. For each UE associated with the core network 140 for an EPS-based system, at a given point of time, there is a single S-GW. The functions of the S-GW 230D, for both the GTP-based and the Proxy Mobile IPv6 (PMIP)-based S5/S8, include: Mobility anchor point, Packet routing and forwarding, and setting the DiffSery Code Point (DSCP) based on a QoS Class Identifier (QCI) of the associated EPS bearer.

Referring to FIG. 2D, the P-GW 235D is the gateway that terminates the SGi interface toward the Packet Data Network (PDN), e.g., the Internet 175. If a UE is accessing multiple PDNs, there may be more than one P-GW for that UE; however, a mix of S5/S8 connectivity and Gn/Gp connectivity is not typically supported for that UE simultaneously. P-GW functions include for both the GTP-based S5/S8: Packet filtering (by deep packet inspection), UE IP address allocation, setting the DSCP based on the QCI of the associated EPS bearer, accounting for inter operator charging, uplink (UL) and downlink (DL) bearer binding as defined in 3GPP TS 23.203, UL bearer binding verification as defined in 3GPP TS 23.203. The P-GW 235D provides PDN connectivity to both GSM/EDGE Radio Access Network (GERAN)/UTRAN only UEs and E-UTRAN-capable UEs using any of E-UTRAN, GERAN, or UTRAN. The P-GW 235D provides PDN connectivity to E-UTRAN capable UEs using E-UTRAN only over the S5/S8 interface.

Referring to FIG. 2D, the PCRF 240D is the policy and charging control element of the EPS-based core network 140. In a non-roaming scenario, there is a single PCRF in the HPLMN associated with a UE's Internet Protocol Connectivity Access Network (IP-CAN) session. The PCRF terminates the Rx interface and the Gx interface. In a roaming scenario with local breakout of traffic, there may be two PCRFs associated with a UE's IP-CAN session: A Home PCRF (H-PCRF) is a PCRF that resides within a HPLMN, and a Visited PCRF (V-PCRF) is a PCRF that resides within a visited VPLMN. PCRF is described in more detail in 3GPP TS 23.203, and as such will not be described further for the sake of brevity. In FIG. 2D, the application server 170 (e.g., which can be referred to as the AF in 3GPP terminology) is shown as connected to the core network 140 via the Internet 175, or alternatively to the PCRF 240D directly via an Rx interface. Generally, the application server 170 (or AF) is an element offering applications that use IP bearer resources with the core network (e.g. UMTS PS domain/GPRS domain resources/LTE PS data services). One example of an application function is the Proxy-Call Session Control Function (P-CSCF) of the IP Multimedia Subsystem (IMS) Core Network sub system. The AF uses the Rx reference point to provide session information to the PCRF 240D. Any other application server offering IP data services over cellular network can also be connected to the PCRF 240D via the Rx reference point.

FIG. 2E illustrates an example of the RAN 120 configured as an enhanced High Rate Packet Data (HRPD) RAN connected to an EPS or LTE network 140A and also a packet-switched portion of an HRPD core network 140B in accordance with an embodiment of the invention. The core network 140A is an EPS or LTE core network, similar to the core network described above with respect to FIG. 2D.

In FIG. 2E, the eHRPD RAN includes a plurality of base transceiver stations (BTSs) 200E, 205E and 210E, which are connected to an enhanced BSC (eBSC) and enhanced PCF (ePCF) 215E. The eBSC/ePCF 215E can connect to one of the MMEs 215D or 220D within the EPS core network 140A over an S101 interface, and to an HRPD serving gateway (HSGW) 220E over A10 and/or A11 interfaces for interfacing with other entities in the EPS core network 140A (e.g., the S-GW 220D over an S103 interface, the P-GW 235D over an S2a interface, the PCRF 240D over a Gxa interface, a 3GPP AAA server (not shown explicitly in FIG. 2D) over an STa interface, etc.). The HSGW 220E is defined in 3GPP2 to provide the interworking between HRPD networks and EPS/LTE networks. As will be appreciated, the eHRPD RAN and the HSGW 220E are configured with interface functionality to EPC/LTE networks that is not available in legacy HRPD networks.

Turning back to the eHRPD RAN, in addition to interfacing with the EPS/LTE network 140A, the eHRPD RAN can also interface with legacy HRPD networks such as HRPD network 140B. As will be appreciated the HRPD network 140B is an example implementation of a legacy HRPD network, such as the EV-DO network from FIG. 2A. For example, the eBSC/ePCF 215E can interface with an authentication, authorization and accounting (AAA) server 225E via an A12 interface, or to a PDSN/FA 230E via an A10 or A11 interface. The PDSN/FA 230E in turn connects to HA 235A, through which the Internet 175 can be accessed. In FIG. 2E, certain interfaces (e.g., A13, A16, H1, H2, etc.) are not described explicitly but are shown for completeness and would be understood by one of ordinary skill in the art familiar with HRPD or eHRPD.

Referring to FIGS. 2B-2E, it will be appreciated that LTE core networks (e.g., FIG. 2D) and HRPD core networks that interface with eHRPD RANs and HSGWs (e.g., FIG. 2E) can support network-initiated Quality of Service (QoS) (e.g., by the P-GW, GGSN, SGSN, etc.) in certain cases.

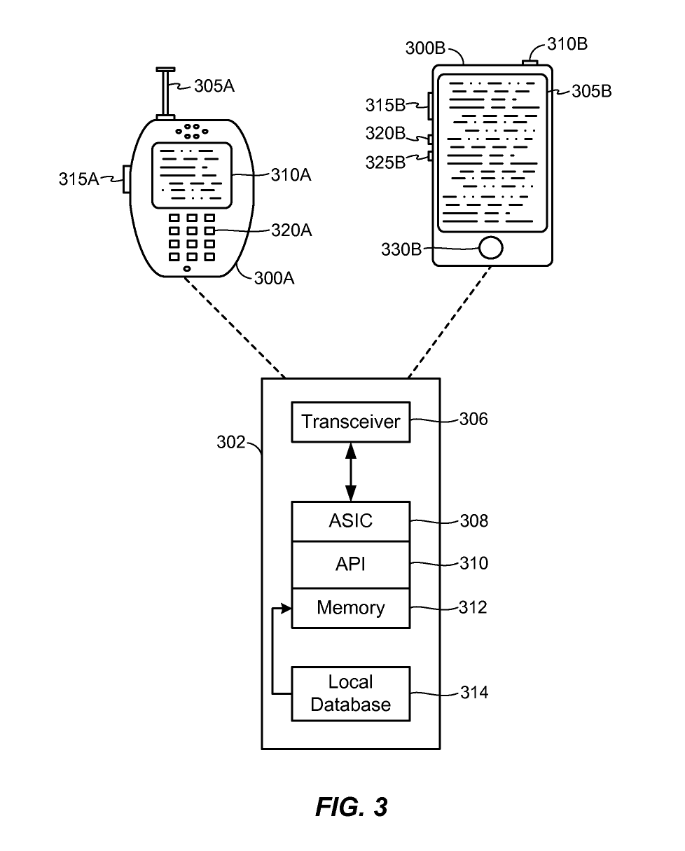

FIG. 3 illustrates examples of UEs in accordance with embodiments of the invention. Referring to FIG. 3, UE 300A is illustrated as a calling telephone and UE 300B is illustrated as a touchscreen device (e.g., a smart phone, a tablet computer, etc.). As shown in FIG. 3, an external casing of UE 300A is configured with an antenna 305A, display 310A, at least one button 315A (e.g., a PTT button, a power button, a volume control button, etc.) and a keypad 320A among other components, as is known in the art. Also, an external casing of UE 300B is configured with a touchscreen display 305B, peripheral buttons 310B, 315B, 320B and 325B (e.g., a power control button, a volume or vibrate control button, an airplane mode toggle button, etc.), at least one front-panel button 330B (e.g., a Home button, etc.), among other components, as is known in the art. While not shown explicitly as part of UE 300B, the UE 300B can include one or more external antennas and/or one or more integrated antennas that are built into the external casing of UE 300B, including but not limited to WiFi antennas, cellular antennas, satellite position system (SPS) antennas (e.g., global positioning system (GPS) antennas), and so on.

While internal components of UEs such as the UEs 300A and 300B can be embodied with different hardware configurations, a basic high-level UE configuration for internal hardware components is shown as platform 302 in FIG. 3. The platform 302 can receive and execute software applications, data and/or commands transmitted from the RAN 120 that may ultimately come from the core network 140, the Internet 175 and/or other remote servers and networks (e.g., application server 170, web URLs, etc.). The platform 302 can also independently execute locally stored applications without RAN interaction. The platform 302 can include a transceiver 306 operably coupled to an application specific integrated circuit (ASIC) 308, or other processor, microprocessor, logic circuit, or other data processing device. The ASIC 308 or other processor executes the application programming interface (API) 310 layer that interfaces with any resident programs in the memory 312 of the wireless device. The memory 312 can be comprised of read-only or random-access memory (RAM and ROM), EEPROM, flash cards, or any memory common to computer platforms. The platform 302 also can include a local database 314 that can store applications not actively used in memory 312, as well as other data. The local database 314 is typically a flash memory cell, but can be any secondary storage device as known in the art, such as magnetic media, EEPROM, optical media, tape, soft or hard disk, or the like.

Accordingly, an embodiment of the invention can include a UE (e.g., UE 300A, 300B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 308, memory 312, API 310 and local database 314 may all be used cooperatively to load, store and execute the various functions disclosed herein and thus the logic to perform these functions may be distributed over various elements. Alternatively, the functionality could be incorporated into one discrete component. Therefore, the features of the UEs 300A and 300B in FIG. 3 are to be considered merely illustrative and the invention is not limited to the illustrated features or arrangement.

The wireless communication between the UEs 300A and/or 300B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

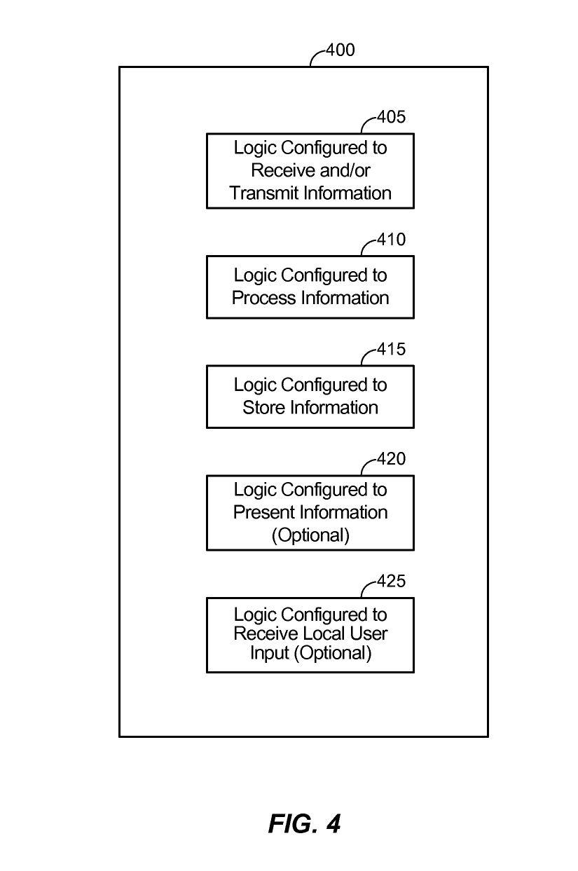

FIG. 4 illustrates a communication device 400 that includes logic configured to perform functionality. The communication device 400 can correspond to any of the above-noted communication devices, including but not limited to UEs 300A or 300B, any component of the RAN 120 (e.g., BSs 200A through 210A, BSC 215A, Node Bs 200B through 210B, RNC 215B, eNodeBs 200D through 210D, etc.), any component of the core network 140 (e.g., PCF 220A, PDSN 225A, SGSN 220B, GGSN 225B, MME 215D or 220D, HSS 225D, S-GW 230D, P-GW 235D, PCRF 240D), any components coupled with the core network 140 and/or the Internet 175 (e.g., the application server 170), and so on. Thus, communication device 400 can correspond to any electronic device that is configured to communicate with (or facilitate communication with) one or more other entities over the wireless communications system 100 of FIG. 1.

Referring to FIG. 4, the communication device 400 includes logic configured to receive and/or transmit information 405. In an example, if the communication device 400 corresponds to a wireless communications device (e.g., UE 300A or 300B, one of BSs 200A through 210A, one of Node Bs 200B through 210B, one of eNodeBs 200D through 210D, etc.), the logic configured to receive and/or transmit information 405 can include a wireless communications interface (e.g., Bluetooth, WiFi, 2G, CDMA, W-CDMA, 3G, 4G, LTE, etc.) such as a wireless transceiver and associated hardware (e.g., an RF antenna, a MODEM, a modulator and/or demodulator, etc.). In another example, the logic configured to receive and/or transmit information 405 can correspond to a wired communications interface (e.g., a serial connection, a USB or Firewire connection, an Ethernet connection through which the Internet 175 can be accessed, etc.). Thus, if the communication device 400 corresponds to some type of network-based server (e.g., PDSN, SGSN, GGSN, S-GW, P-GW, MME, HSS, PCRF, the application 170, etc.), the logic configured to receive and/or transmit information 405 can correspond to an Ethernet card, in an example, that connects the network-based server to other communication entities via an Ethernet protocol. In a further example, the logic configured to receive and/or transmit information 405 can include sensory or measurement hardware by which the communication device 400 can monitor its local environment (e.g., an accelerometer, a temperature sensor, a light sensor, an antenna for monitoring local RF signals, etc.). The logic configured to receive and/or transmit information 405 can also include software that, when executed, permits the associated hardware of the logic configured to receive and/or transmit information 405 to perform its reception and/or transmission function(s). However, the logic configured to receive and/or transmit information 405 does not correspond to software alone, and the logic configured to receive and/or transmit information 405 relies at least in part upon hardware to achieve its functionality.

Referring to FIG. 4, the communication device 400 further includes logic configured to process information 410. In an example, the logic configured to process information 410 can include at least a processor. Example implementations of the type of processing that can be performed by the logic configured to process information 410 includes but is not limited to performing determinations, establishing connections, making selections between different information options, performing evaluations related to data, interacting with sensors coupled to the communication device 400 to perform measurement operations, converting information from one format to another (e.g., between different protocols such as .wmv to .avi, etc.), and so on. For example, the processor included in the logic configured to process information 410 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 410 can also include software that, when executed, permits the associated hardware of the logic configured to process information 410 to perform its processing function(s). However, the logic configured to process information 410 does not correspond to software alone, and the logic configured to process information 410 relies at least in part upon hardware to achieve its functionality.

Referring to FIG. 4, the communication device 400 further includes logic configured to store information 415. In an example, the logic configured to store information 415 can include at least a non-transitory memory and associated hardware (e.g., a memory controller, etc.). For example, the non-transitory memory included in the logic configured to store information 415 can correspond to RAM memory, flash memory, ROM memory, EPROM memory, EEPROM memory, registers, hard disk, a removable disk, a CD-ROM, or any other form of storage medium known in the art. The logic configured to store information 415 can also include software that, when executed, permits the associated hardware of the logic configured to store information 415 to perform its storage function(s). However, the logic configured to store information 415 does not correspond to software alone, and the logic configured to store information 415 relies at least in part upon hardware to achieve its functionality.

Referring to FIG. 4, the communication device 400 further optionally includes logic configured to present information 420. In an example, the logic configured to present information 420 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 400. For example, if the communication device 400 corresponds to UE 300A or UE 300B as shown in FIG. 3, the logic configured to present information 420 can include the display 310A of UE 300A or the touchscreen display 305B of UE 300B. In a further example, the logic configured to present information 420 can be omitted for certain communication devices, such as network communication devices that do not have a local user (e.g., network switches or routers, remote servers, etc.). The logic configured to present information 420 can also include software that, when executed, permits the associated hardware of the logic configured to present information 420 to perform its presentation function(s). However, the logic configured to present information 420 does not correspond to software alone, and the logic configured to present information 420 relies at least in part upon hardware to achieve its functionality.

Referring to FIG. 4, the communication device 400 further optionally includes logic configured to receive local user input 425. In an example, the logic configured to receive local user input 425 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 400. For example, if the communication device 400 corresponds to UE 300A or UE 300B as shown in FIG. 3, the logic configured to receive local user input 425 can include the keypad 320A, any of the buttons 315A or 310B through 325B, the touchscreen display 305B, etc. In a further example, the logic configured to receive local user input 425 can be omitted for certain communication devices, such as network communication devices that do not have a local user (e.g., network switches or routers, remote servers, etc.). The logic configured to receive local user input 425 can also include software that, when executed, permits the associated hardware of the logic configured to receive local user input 425 to perform its input reception function(s). However, the logic configured to receive local user input 425 does not correspond to software alone, and the logic configured to receive local user input 425 relies at least in part upon hardware to achieve its functionality.

Referring to FIG. 4, while the configured logics of 405 through 425 are shown as separate or distinct blocks in FIG. 4, it will be appreciated that the hardware and/or software by which the respective configured logic performs its functionality can overlap in part. For example, any software used to facilitate the functionality of the configured logics of 405 through 425 can be stored in the non-transitory memory associated with the logic configured to store information 415, such that the configured logics of 405 through 425 each performs their functionality (i.e., in this case, software execution) based in part upon the operation of software stored by the logic configured to store information 415. Likewise, hardware that is directly associated with one of the configured logics can be borrowed or used by other configured logics from time to time. For example, the processor of the logic configured to process information 410 can format data into an appropriate format before being transmitted by the logic configured to receive and/or transmit information 405, such that the logic configured to receive and/or transmit information 405 performs its functionality (i.e., in this case, transmission of data) based in part upon the operation of hardware (i.e., the processor) associated with the logic configured to process information 410.

Generally, unless stated otherwise explicitly, the phrase “logic configured to” as used throughout this disclosure is intended to invoke an embodiment that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

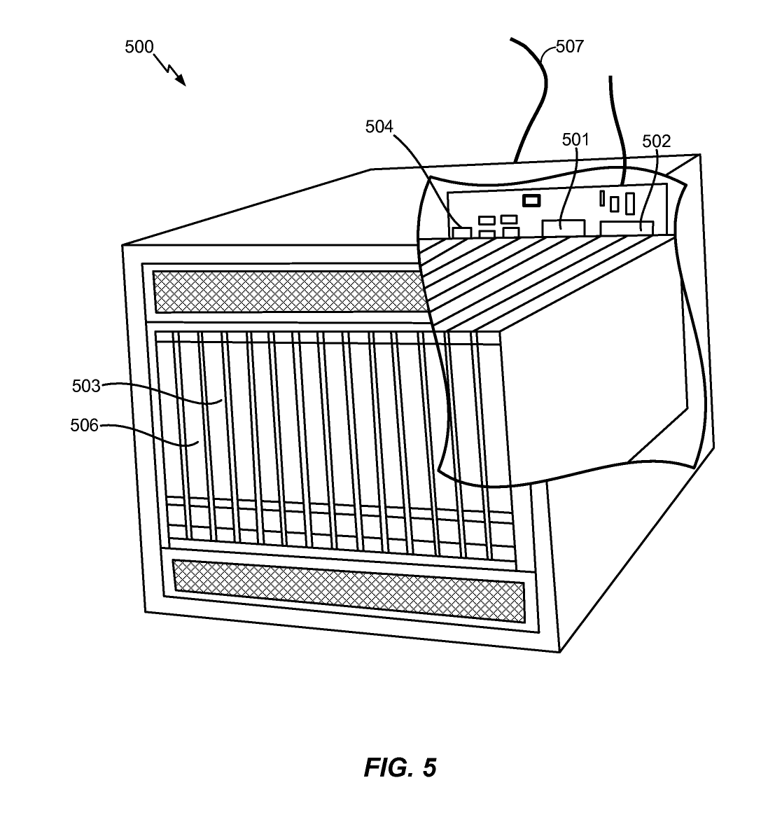

The various embodiments may be implemented on any of a variety of commercially available server devices, such as server 500 illustrated in FIG. 5. In an example, the server 500 may correspond to one example configuration of the application server 170 described above. In FIG. 5, the server 500 includes a processor 500 coupled to volatile memory 502 and a large capacity nonvolatile memory, such as a disk drive 503. The server 500 may also include a floppy disc drive, compact disc (CD) or DVD disc drive 506 coupled to the processor 501. The server 500 may also include network access ports 504 coupled to the processor 501 for establishing data connections with a network 507, such as a local area network coupled to other broadcast system computers and servers or to the Internet. In context with FIG. 4, it will be appreciated that the server 500 of FIG. 5 illustrates one example implementation of the communication device 400, whereby the logic configured to transmit and/or receive information 405 corresponds to the network access ports 504 used by the server 500 to communicate with the network 507, the logic configured to process information 410 corresponds to the processor 501, and the logic configuration to store information 415 corresponds to any combination of the volatile memory 502, the disk drive 503 and/or the disc drive 506. The optional logic configured to present information 420 and the optional logic configured to receive local user input 425 are not shown explicitly in FIG. 5 and may or may not be included therein. Thus, FIG. 5 helps to demonstrate that the communication device 400 may be implemented as a server, in addition to a UE implementation as in 305A or 305B as in FIG. 3.

In typical client device implementations, application-layer client applications (e.g., mobile web browsers operating in accordance with WebRTC, VoIP applications managing one or more VoIP sessions, etc.) are not aware of whether their packets are allocated header compression (e.g., such as Robust Header Compression (RoHC)) at lower layers (e.g., transport and/or physical layers) of a UE. Instead, the application-layer client applications will simply exchange a stream of packets to/from the lower layers without knowing whether header compression is being used to send/receive the stream of packets between the lower layers of the UE and one or more external entities (e.g., such as a base station or eNodeB).

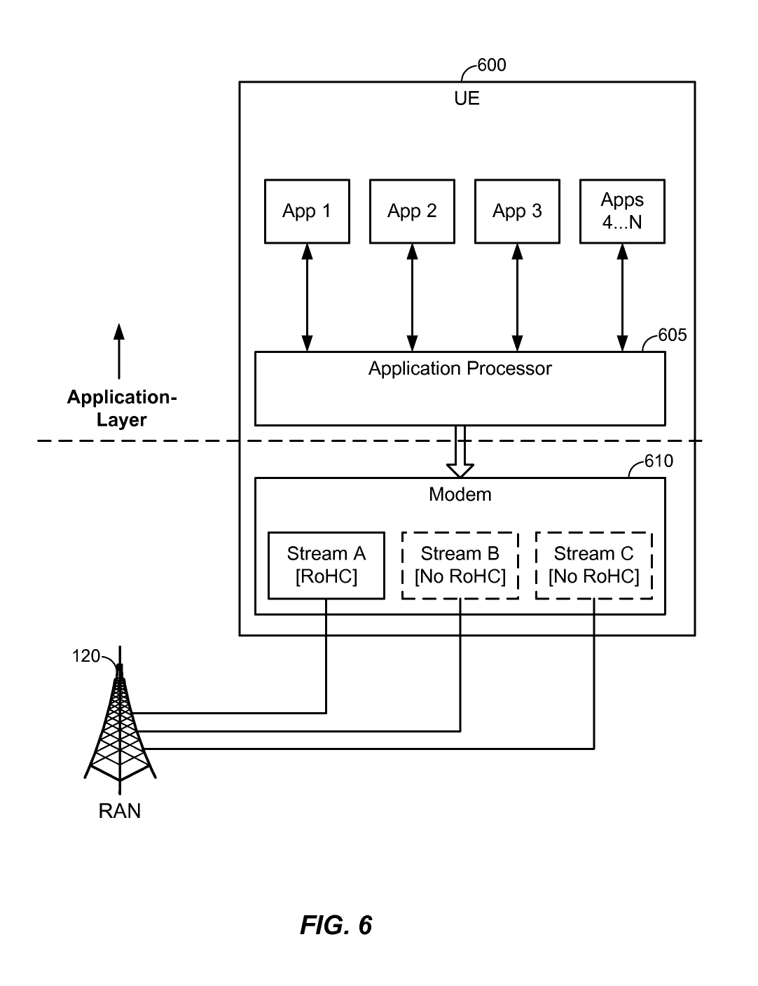

FIG. 6 illustrates a UE 600 in accordance with an embodiment of the invention. Referring to FIG. 6, the UE 600 includes a plurality of client applications (“Apps 1 . . . N”) that operate at the application-layer, an application processor 605 and a modem 610. Conventionally, the modem 610 is not configured to provide information to the application processor 605 and/or to Apps 1 . . . N with respect to, among other things, whether header compression (e.g., such as RoHC) is being used for one or more streams being managed by the modem 610. As shown in FIG. 6, the modem 610 manages streams A, B and C (e.g., although the modem could manage more or fewer streams in other scenarios), whereby each stream corresponds to a stream of data packets being communicated in an uplink and/or a downlink with the RAN 120. In FIG. 6, stream A uses RoHC on traffic exchanged between the UE 600 and the RAN 120, and streams B and C do not use RoHC. Conventionally, the modem 610 is aware of the RoHC to apply to the respective streams, but this knowledge is not passed up to the application processor 605 and/or any of the application-layer Apps 1 . . . N.

Embodiments of the invention are related to using a delay disparity between streams, that is calculated based on delay measurements measured at an external entity (e.g., a target UE or a server), in order to determine whether header compression (e.g., RoHC) is being used on a particular stream at one or more application-layer client applications, such as Apps 1 . . . N in FIG. 6. In particular, even where the lower-layers (or modem) of a particular UE do not support an internal reporting or notification function of stream-specific header compression parameters to the UE's application-layer client applications, a given application-layer client application can still figure out whether header compression is used for any of its respective streams.

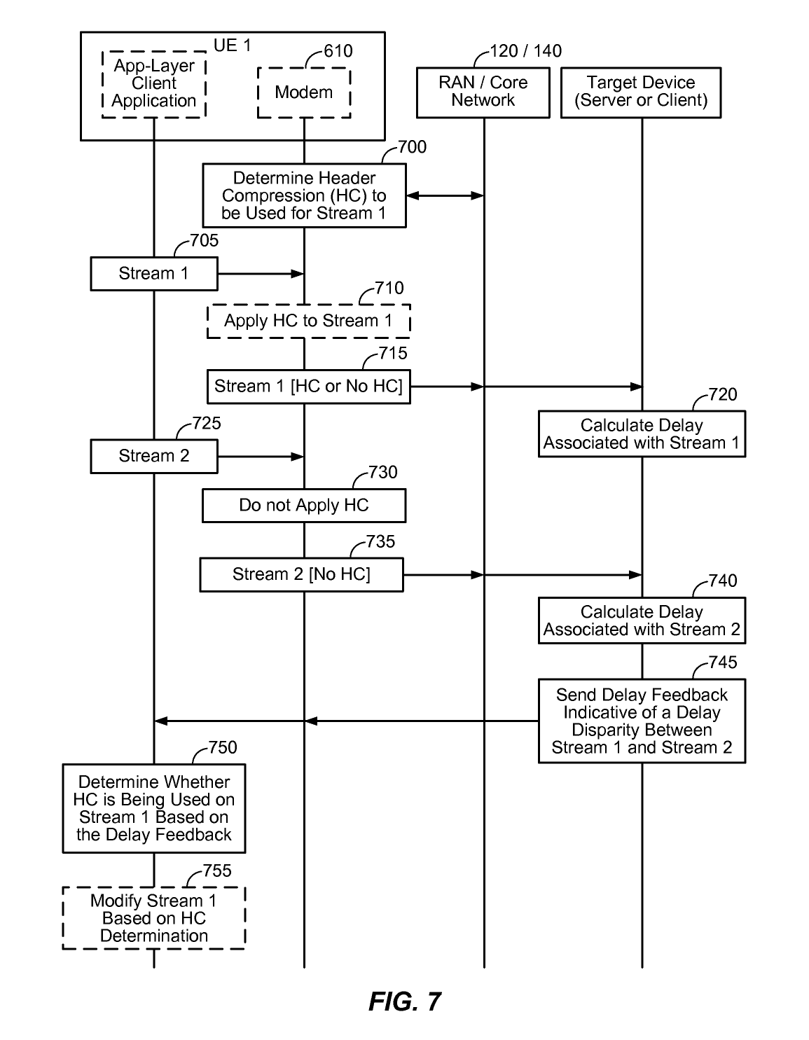

FIG. 7 illustrates a process by which an application-layer client application determines whether one of its streams is using header compression in accordance with an embodiment of the invention. Referring to FIG. 7, the modem 610 establishes a header compression profile to be applied to one or more different types of streams, 700. In an LTE-specific example, the modem 610 can execute an attach procedure with the Evolved Packet Core (EPC) at 700 to establish a set of RoHC profiles to be applied to streams supporting one or more application-layer client applications, such as VoIP applications (e.g., use RoHC for a media or Realtime Transport Protocol (RTP) stream for supporting VoIP media of VoIP sessions, do not use RoHC for a signaling stream related to the VoIP sessions, etc.).

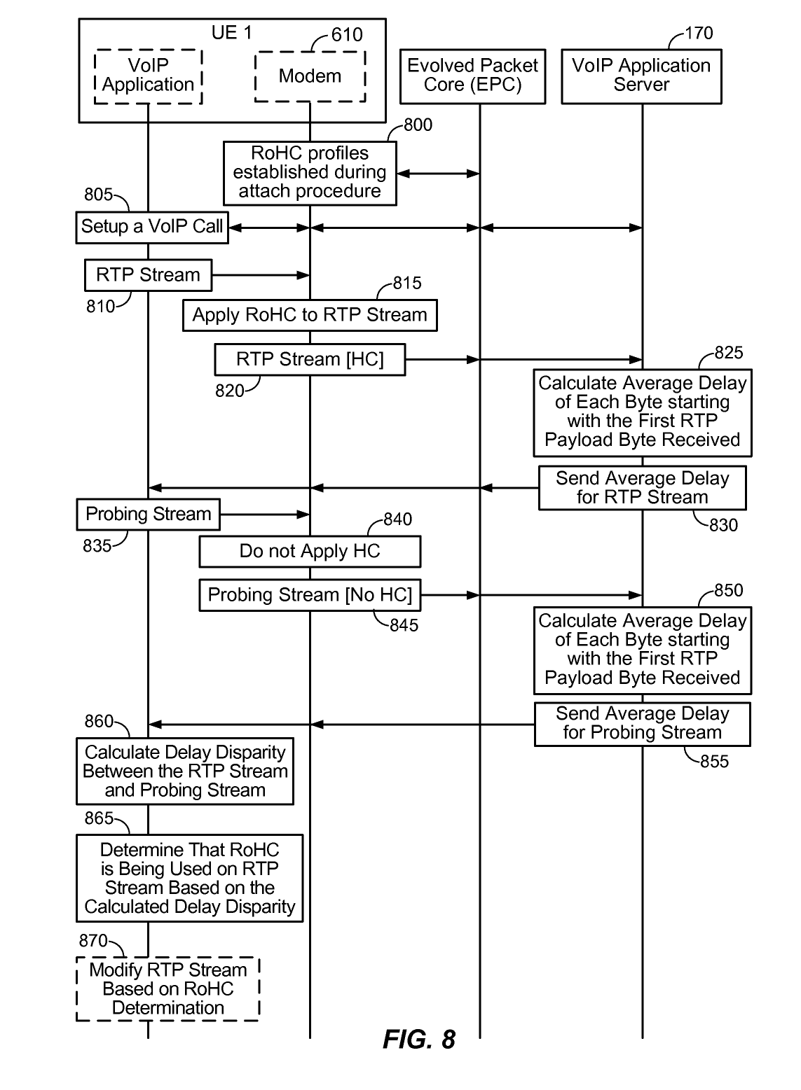

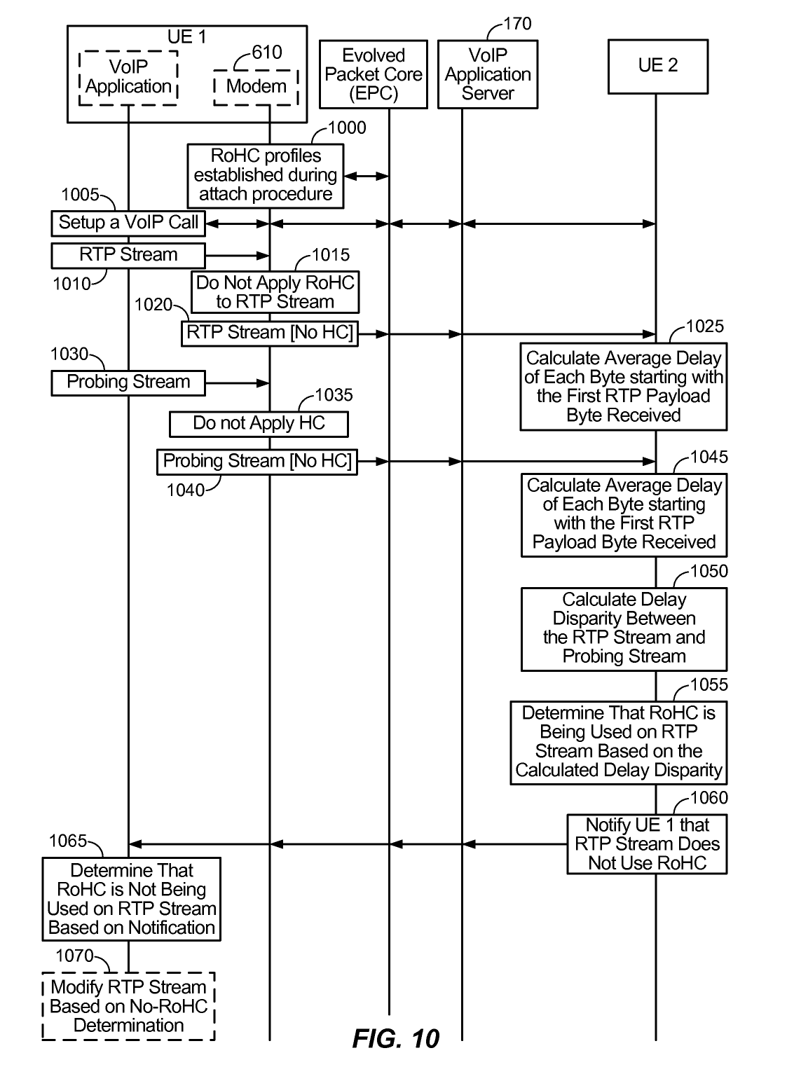

At some later point in time, a communication session is instantiated between UE 1 and at least one target UE whereby a given application-layer client application on UE 1 begins to send a first stream (“stream 1”) to the modem 610 for transmission to a target device. The modem 610 selectively applies header compression to stream 1 based on stream l's associated header compression profile from 700, 710, and then transmits the resultant stream to the target device, 715. In the embodiment of FIG. 7, the target device can correspond to a server (e.g., such as the application server 170) that is arbitrating the communication session between UE 1 and the target UE(s), or alternatively the target device can correspond to one of the target UE(s). Thereby, while not shown in FIG. 7 explicitly, if the target device is the application server 170, the application server 170 can forward stream 1 to the target UE(s) engaged in the communication session with UE 1. Below, FIG. 8 relates to an example implementation of FIG. 7 whereby the target device is the application server 170, while FIG. 10 relates to an example implementation of FIG. 7 whereby the target device is a target UE.

Referring to FIG. 7, as the target device receives stream 1, the target device calculates a delay associated with the packets of stream 1, 720. In an example whereby stream 1 is an RTP stream, at 720, the target device can use delays associated with RTP payload bytes within RTP packets in stream 1 from 715 to calculate the average delay associated with each byte of stream 1 starting from the first RTP payload byte received in order to calculate the average delay per-byte. For example, assume that RTP/UDP/IP headers for RoHC packets in a RoHC stream include an average of 3 bytes per RoHC packet, and further that RTP/UDP/IP headers for non-RoHC packets in a non-RoHC stream include an average of 40 bytes per non-ROHC packet. In this case, the arrival times of voice frames in the non-RoHC stream will have more delay than the arrival times of corresponding voice frames in the RoHC stream due to the increased average header size for non-RoHC packets in the RoHC stream.

In FIG. 7, stream 1 is transmitted at 705-715 either with or without header compression, and the header compression status is not yet known by the given application-layer client application. At 725, in order for the given application-layer client application to figure out whether stream 1 is using header compression, the given application-layer client application configures a second stream of packets (“stream 2”) for delivery to the target device without any header compression, and then sends stream 2 to the modem 610 for transmission to the target device. In an example, the given application-layer client application can guarantee that header compression is not applied to stream 2 by ensuring that stream 2 is not associated with any of the header compression profiles established at 700. For example, the Stream Control Transmission Protocol (SCTP) is currently not associated with any header compression profile, so establishing stream 2 with SCTP can guarantee that no header compression is applied to stream 2 under current standards. As an alternative, a custom non-SCTP protocol on top of UDP/IP could also be used, as this would also not be associated with a header compression profile. The modem 610 does not apply header compression to stream 2, 730, and the modem 610 transmits stream 2 (without header compression) to the target device, 735. As the target device receives stream 2, the target device calculates a delay associated with the packets of stream 2, 740.

In an example, at 740, the target device can use delays associated with payload bytes within packets in stream 2 from 735 to calculate the average delay associated with each byte of stream 2 starting from the first payload byte received in order to calculate the average delay per-byte (e.g., similar to 720). While the transmissions of stream 1 and stream 2 are illustrated in consecutive fashion in FIG. 7 (e.g., stream 1 followed by stream 2), it will be appreciated that the transmissions of streams 1 and 2, as well as their associated delay calculations, can occur in parallel.

Referring to FIG. 7, the target device sends delay feedback indicative of a delay disparity between stream 1 and stream 2 to the given application-layer client application on UE 1, 745. The delay feedback that is sent to UE 1 at 745 can be configured in several different ways. In a first example (e.g., as shown in FIG. 8), the target device can separately send the stream 1 delay calculated at 720 and the stream 2 delay calculated at 740 as the delay feedback, such that the given application-layer client application on UE 1 is relied upon for calculating the associated delay disparity and then figuring out whether header compression is being used for stream 1. In this example, the delay feedback is indicative of the delay disparity because the delay feedback can be used by UE 1 to calculate the delay disparity.

In a second example, the target device can calculate the delay disparity itself (e.g., by calculating a difference between the stream 1 delay calculated at 720 and the stream 2 delay calculated at 740) and can send the calculated delay disparity to the given application-layer client application on UE 1, such that the given application-layer client application on UE 1 is relied upon for figuring out whether header compression is being used for stream 1. In this example, the delay feedback is indicative of the delay disparity because the delay feedback expressly or explicitly identifies the delay disparity.

In a third example (e.g., as shown in FIG. 10), the target device can calculate the delay disparity itself and also make a decision as to whether header compression is being used for stream 1. In this case, instead of reporting any actual delay data to the given application-layer client application on UE 1, the target device need only notify the given application-layer client application on UE 1 as to whether stream 1 is using header compression. In this example, the delay feedback is indicative of the delay disparity because a header compression indication implies a relatively high delay disparity while a no-header compression indication implies a relatively low delay disparity.

The given application-layer client application on UE 1 receives the delay feedback from 745, and then determines whether header compression is being used on stream 1 based on the delay feedback, 750. As will be appreciated from the description of 745 above, if the delay feedback includes the delay calculated at 720 and 740, the determination of 750 can include calculating the delay disparity and then using the calculated delay disparity to determine whether header compression is being used on stream 1. If the delay feedback includes the calculated delay disparity, the determination of 750 can include using the calculated delay disparity from the delay feedback to determine whether header compression is being used on stream 1. If the delay feedback includes an explicit indication with regard to whether header compression is being used on stream 1, the determination of 750 can include successful receipt of the explicit indication.

In FIG. 7, irrespective of whether the delay disparity is used at the target device or on UE 1 itself to figure out whether header compression is being used on stream 1, the magnitude of the delay disparity can be compared against a delay disparity threshold (e.g., 0 ms, 40 ms, 60 ms, etc.) to make the header compression determination. In a more specific example, whenever the delay disparity indicates that the payload bytes of stream 1 lags behind the payload bytes of stream 2 by more than the delay disparity threshold, stream 1 is interpreted as using header compression.

Referring to FIG. 7, at 755, the given application-layer client application optionally modifies stream 1 based at least in part upon the header compression determination. The stream modification implemented at 755 is optional in FIG. 7 because stream 1 may already be configured in accordance with the appropriate settings to accommodate the header compression determination (or lack thereof) from 750. For example, at 755, if the given application-layer client application determines that header compression is being used by stream 1 at 750, the given application-layer client application (if necessary) can select a different transcoding scheme for stream 1 to take advantage of the header compression, increase an image, video and/or audio resolution used by stream 1, increase a bandwidth or bit-rate used by stream 1 (e.g., for voice or speech frames), adjust a macroblock ordering for stream 1, decrease a bundling factor for stream 1 (e.g., so that more media frames are sent in independent packet transmissions), and/or refrain from implementing a forward error correction mechanism (or at least reduce an aggressiveness of the forward error correction mechanism) based on implementation of the reduced bundling factor because loss of any particular RTP packet would only affect a single voice frame (instead of multiple voice frames if the bundling factor is higher).

In a more specific transcoding example in response to an affirmative header compression determination, the transmitting entity (i.e., UE 1) can budget more bits/bytes at the source encoding level so that artifacts associated with transcoding are reduced. In a more specific bandwidth increment example in response to an affirmative header compression determination, the transmitting entity (i.e., UE 1) can allocate more bandwidth to stream 1 which is used to redundantly send pictures and slices for a video frame that would typically incur bandwidth overhead but helps to protect against error propagation in video communications. In a more specific macroblock example in response to an affirmative header compression determination, the transmitting entity (i.e., UE 1) can use flexible macroblock ordering within a video frame which typically requires more bits, but imparts resiliency in case of packet errors. In a more specific bundling example in response to an affirmative header compression determination, if the given application-layer client application determines that stream 1 carries 20 ms VoIP voice frames and uses RoHC for RTP/UDP/IP traffic at 750, the given application-layer client application can reduce a bundling factor for voice frames to 1 such that each packet includes a single voice frame, and the target device thereby only has to wait 20 ms before receiving each successive frame. By contrast, if the bundling factor is 6 such that 6 voice frames are bundled in each packet, the target device would need to wait 120 ms for each successive packet.

Alternatively, at 755, if the given application-layer client application determines that header compression is not being used by stream 1 at 750, the given application-layer client application (if necessary) can select a different transcoding scheme for stream 1 to accommodate the lack of header compression, decrease an image, video and/or audio resolution used by stream 1, decrease a bandwidth or bit-rate used by stream 1 (e.g., for voice or speech frames), adjust a macroblock ordering for stream 1, increase a bundling factor for stream 1 (e.g., so that fewer media frames are sent in independent packet transmissions), and/or implement a more aggressive forward error correction mechanism based on implementation of the increased bundling factor because loss of any particular RTP packet would only affect a single voice frame (instead of multiple voice frames if the bundling factor is higher).

In a more specific transcoding example in response to a negative header compression determination, the transmitting entity (i.e., UE 1) can budget fewer bits/bytes at the source encoding level. In a more specific bandwidth decrement example in response to a negative header compression determination, the transmitting entity (i.e., UE 1) can allocate less bandwidth to stream 1 by withdrawing support for a redundant transmission of pictures and slices for a video frame. In a more specific macroblock example in response to a negative header compression determination, the transmitting entity (i.e., UE 1) can use inflexible macroblock ordering within a video frame which typically requires fewer bits as compare to a flexible macroblock ordering. In a more specific bundling example in response to a negative header compression determination, if the given application-layer client application determines that stream 1 carries 20 ms VoIP voice frames without RoHC for RTP/UDP/IP traffic at 750, the given application-layer client application can increase a bundling factor for voice frames to 6 such that each packet includes 6 voice frames, and the target device thereby has to wait 120 ms before receiving each successive frame. In this case, increasing the bundling factor helps to reduce the payload-to-header ratio associated with traffic on stream 1 due to the relatively large RTP packet header. By contrast, if the bundling factor is 1 such that a single voice frame is bundled in each packet, the target device would wait only 20 ms for each successive packet at the cost of reducing the payload-to-header ratio for stream 1.

FIG. 8 illustrates a more detailed implementation of the process of FIG. 7 in accordance with an embodiment of the present invention. Referring to FIG. 8, the modem 610 establishes a set of RoHC profiles during an attach procedure with the EPC, 800 (e.g., similar to 700 of FIG. 7). At some later point in time, a VoIP application on UE 1 sets up a VoIP call to be arbitrated by the application server 170 (e.g., which is a VoIP application server in the embodiment of FIG. 8), 805. After the VoIP call is setup at 805, the VoIP application begins to send an RTP stream carrying voice frames to the modem 610 for transmission to a target device, 810 (e.g., similar to 705 of FIG. 7). In the embodiment of FIG. 8, the target device is the application server 170 even though the ultimate destination of the RTP stream is likely to be one or more target UEs. This means that the application server 170 is the entity responsible for providing the delay feedback in FIG. 8, even though it is possible for the target UE(s) to be the entit(ies) responsible for providing the delay feedback in a different implementation as described below with respect to FIG. 10.

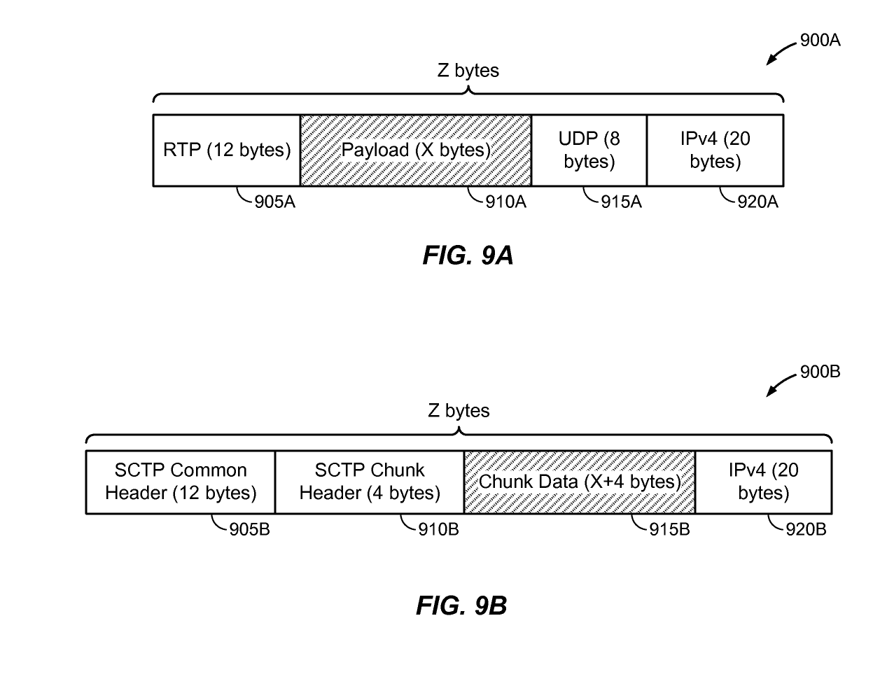

The modem 610 applies RoHC to the RTP stream based on the RTP stream's associated RoHC profile from 800, 815 (e.g., similar to 710 of FIG. 7), and then transmits the resultant RTP stream to the application server, 820. While not shown in FIG. 8 explicitly, the application server 170 can forward the RTP stream to the target UE(s) engaged in the communication session with UE 1. Below, FIG. 9A illustrates an example configuration of the RTP packets used by the RTP stream at 810-820.

Referring to FIG. 8, as the application server 170 receives the RTP stream, the application server 170 calculates an average delay associated with the RTP payload bytes of RTP packets within the RTP stream starting with the first RTP payload byte received at the application server 170 for the RTP stream, 825 (e.g., similar to 720 of FIG. 7). The application server 170 reports the calculated average delay from 825 to the VoIP application on UE 1 (e.g., a single time, on a periodic basis, whenever the calculated average delay changes during the VoIP session, etc.), 830 (e.g., similar to 745 of FIG. 7). In an example, the calculated average delay for the RTP stream can be reported at 830 via a SIP message, an RTCP message or a custom message-type.

At 835 (e.g., similar to 725 of FIG. 7), in order for the VoIP application to figure out whether the RTP stream is using header compression, the VoIP application configures a second stream of packets (“probing stream”) for delivery to the application server 170 without RoHC, and then sends the probing stream to the modem 610 for transmission to the application server 170. The modem 610 does not apply RoHC to the probing stream, 840 (e.g., similar to 730 of FIG. 7), and the modem 610 transmits the probing stream (without RoHC) to the application server 170, 845 (e.g., similar to 735 of FIG. 7). Below, FIG. 9B illustrates an example configuration of the probing packets used by the probing stream at 835-845.

Referring to FIG. 8, as the application server 170 receives the probing stream, the application server 170 calculates an average delay associated with the payload bytes of probing packets within the probing stream starting with the first payload byte received at the application server 170 for the probing stream, 850 (e.g., similar to 740 of FIG. 7). The application server 170 reports the calculated average delay from 850 to the VoIP application on UE 1 (e.g., a single time, on a periodic basis, whenever the calculated average delay changes during the VoIP session for the probing stream, etc.), 855 (e.g., similar to 745 of FIG. 7). In an example, the calculated average delay for the probing stream can be reported at 855 via a SIP message, an RTCP message or a custom message-type.

Referring to FIG. 8, the VoIP application on UE 1 calculates the delay disparity between the RTP stream and the probing stream, 860 (e.g., by subtracting the average delay for the RTP stream reported at 830 from the average delay for the RTP stream reported at 855). Then, based on the delay disparity from 860, UE 1 determines that RoHC is being used on the RTP stream, 865 (e.g., 860 and 865 collectively correspond to 750 from FIG. 7). For example, the VoIP application can determine that the RTP stream uses RoHC based on the delay disparity indicating that the average delay of RTP payload bytes of RTP packets from the RTP stream is higher than the average delay of payload bytes of probing packets from the probing stream by more than the delay disparity threshold (e.g., 0 ms, 40 ms, 60 ms, etc.). At this point, the VoIP application optionally modifies the RTP stream based at least in part upon the RoHC determination, 870 (e.g., as discussed above with respect to 755 of FIG. 7).

FIG. 9A illustrates an example configuration of an RTP packet 900A in the RTP stream of FIG. 8 in accordance with an embodiment of the present invention, and FIG. 9B illustrates an example configuration of a probing packet 900B in the probing stream of FIG. 8 in accordance with an embodiment of the present invention.

Referring to FIG. 9A, the RTP packet 900A includes a total of Z bytes, with 12 bytes allocated to an RTP header 905A, X bytes allocated to a payload portion 910A (e.g., carrying the voice frame(s)), 8 bytes allocated to a UDP header 915A and 20 bytes allocated to an IPv4 header 920A. In an example, X can be a constant, such that each RTP packet in the RTP stream can have the same payload size.

Referring to FIG. 9B, in order to ensure that the probing stream is not allocated RoHC, the probing packet 900B is implemented as a Stream Control Transmission Protocol (SCTP) packet for which a RoHC does not exist. As an alternative to SCTP, the probing packet could also be implemented using any custom protocol on top of IP that the VoIP application knows will not be allocated RoHC in other embodiments of the invention. Similar to the RTP packet 900A, the probing packet 900B also includes a total of Z bytes so that size variations between respective packets of the RTP and probing streams do not impact their respective calculated average delays. The Z bytes of the probing packet 900B comprise 12 bytes allocated to a SCTP Common header 905B, 4 bytes allocated to a SCTP Chunk header, X+4 bytes allocated to a Chunk data portion 915B and 20 bytes allocated to an IPv4 header 920B. In an example, X can be a constant, such that each probing packet in the probing stream can have the same Chunk data size. As will be appreciated, because the probing packet 900B does not use RoHC, the average delay of the payload bytes in the chunk data portion 915B will be lower than same-sized RTP packets that use RoHC.

While FIG. 8 relates to an example implementation of FIG. 7 whereby the target device is the application server 170, FIG. 10 by contrast relates to another example implementation of FIG. 7 whereby the target device is another UE (“UE 2”) engaged in the VoIP call with UE 1 and UE 2 itself. Also, while FIG. 8 relates to an example implementation of FIG. 7 whereby the application server 170 reports the calculated average delays for the RTP and probing streams back to the VoIP application on UE 1 such that the VoIP application itself is responsible for deriving the delay disparity in order to make the RoHC determination for the RTP stream, FIG. 10 by contrast has UE 2 calculate the display disparity and makes the RoHC determination for the RTP stream such that UE 1 receives an explicit indication from UE 2 with regard to whether RoHC is being used on the RTP stream. Also, while FIG. 8 relates to an example implementation of FIG. 7 whereby the RoHC is being used on the RTP stream, FIG. 10 by contrast relates to an example whereby RoHC is not being used on the RTP stream.

With this in mind, referring to FIG. 10, 1000 through 1025 substantially correspond to 800 through 825 of FIG. 8, respectively, except for (i) the RTP stream terminating at UE 2 in FIG. 10 instead of the application server 170 as in FIG. 8, and (ii) the RTP stream of FIG. 10 not using RoHC while the RTP stream of FIG. 8 uses RoHC. Also, 1030 through 1045 substantially correspond to 835 through 850 of FIG. 8, respectively, except for the probing stream terminating at UE 2 in FIG. 10 instead of the application server 170 as in FIG. 8. In FIG. 10, instead of sending the calculated average delays to UE 1 so that UE 1 can calculate the delay disparity (e.g., as shown 830 and 855-860 of FIG. 8), UE 2 calculates the delay disparity between the RTP and probing streams, 1050. The calculation of 1050 can be executed similarly or identically to 860 of FIG. 8 except for being performed at UE 2 instead of UE 1. Likewise, in FIG. 10, UE 2 also uses the calculated delay disparity to determine whether RoHC is being used on the RTP stream, 1055. The determination of 1055 can be executed similarly to 865 of FIG. 8, except UE 2 determines that RoHC is not used on the RTP stream at 1055 of FIG. 10. After making the determination for the RTP stream at 1055, UE 2 transmits a notification to UE 1 that expressly or explicitly indicates that the RTP stream is not using RoHC, 1060 (e.g., via a SIP message, an RTCP message or a custom message-type). Based on receipt of the notification from 1060, the VoIP application on UE 1 determines that RoHC is not being used on the RTP stream for the VoIP call, 1065, and the VoIP application optionally modifies one or more setting associated with the RTP stream based on the no-RoHC determination, 1070.

In FIG. 10, it is appreciated that the operations described as being performed by UE 2 can be more specifically implemented by a VoIP application that is executing at UE 2 at the application-layer in at least one embodiment of the invention. In this case, both UE 1 and UE 2 may be configured similar to UE 600 from FIG. 6.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of operating an apparatus, comprising:
receiving a first stream and a second stream for a given communication session that originates from an application-layer client application on a source client device;
calculating a first delay of arrival times for packet payload portions within the first stream;
calculating a second delay of arrival times for packet payload portions within the second stream; and
reporting information that is indicative of a delay disparity between the first and second delays to the application-layer client application on the source client device.

2. The method of claim 1, wherein the first stream is a Real-time Transport Protocol (RTP) stream carrying media for the given communication session.

3. The method of claim 1, wherein the second stream is a probing stream that is provided by the source client device and configured to permit the delay disparity to be detected.

4. The method of claim 3, wherein the probing stream is a Stream Control Transmission Protocol (SCTP) stream.

5. The method of claim 1,
wherein the first delay corresponds to a first average delay per payload byte of a first set of payload bytes from the first stream, and
wherein the second delay corresponds to a second average delay per payload byte of a second set of payload bytes from the second stream.

6. The method of claim 1,
wherein the second stream does not use header compression of a given type, and
wherein the delay disparity between the first and second delays is indicative of whether the header compression of the given type is used for the first stream.

7. The method of claim 6, wherein the header compression of the given type is Robust Header Compression (RoHC).

8. The method of claim 1, wherein the reported information indicates the first and second delays.

9. The method of claim 1, wherein the reported information indicates the delay disparity.

10. The method of claim 1, further comprising:
calculating the delay disparity at the apparatus;
determining whether header compression of a given type is used for the first stream based on the delay disparity,
wherein the reported information includes an explicit indication of whether the header compression of the given type is used for the first stream.

11. The method of claim 10, wherein the header compression of the given type is Robust Header Compression (RoHC).

12. The method of claim 1, further comprising:
after the reporting, continuing to receive the first stream with one or more parameters that are modified based on the reported information.

13. The method of claim 12, wherein the one or more modified parameters include a transcoding scheme used by the first stream, a macroblock ordering scheme used by the first stream, an image, video or audio resolution used by the first stream, a bandwidth or bit-rate used by the first stream, a bundling factor of the first stream, whether a forward error correction mechanism is used by the first stream and/or a type or degree of forward error correction mechanism used by the first stream.

14. The method of claim 13,
wherein the one or more modified parameters include the transcoding scheme used by the first stream,
wherein the transcoding scheme is modified to include a higher data budget at a source encoding level if the header compression of the given type is determined to be used, and
wherein the transcoding scheme is not modified to include the higher data budget at the source encoding level if the header compression of the given type is determined not to be used.

15. The method of claim 13,
wherein the one or more modified parameters includes the bundling factor used by the first stream,
wherein the bundling factor is maintained at a higher bundling level or increased to the higher bundling level if the header compression of the given type is determined to be used, and
wherein the bundling factor is maintained at a lower bundling level or decreased to the lower bundling level if the header compression of the given type is determined not to be used.

16. The method of claim 1,
wherein the apparatus is a server mediating the given communication session between the source client device and a target client device, or
wherein the apparatus is the target client device.

17. A method of operating an application-layer client application on a source client device, comprising:
transmitting a first stream and a second stream for a given communication session to a target device;
receiving information that is indicative of, as calculated at the target device, a first delay of arrival times for packet payload portions within the first stream and a second delay of arrival times for packet payload portions within the second stream;
determining whether header compression of a given type is used for the first stream based on the received information; and
selectively modifying one or more parameters of the first stream based on the determination.

18. The method of claim 17, wherein the first stream is a Real-time Transport Protocol (RTP) stream carrying media for the given communication session.

19. The method of claim 17, wherein the second stream is a probing stream that is provided by the source client device and configured to permit the delay disparity to be detected.

20. The method of claim 19, wherein the probing stream is a Stream Control Transmission Protocol (SCTP) stream.

21. The method of claim 17,
wherein the first delay corresponds to a first average delay per payload byte of a first set of payload bytes from the first stream, and
wherein the second delay corresponds to a second average delay per payload byte of a second set of payload bytes from the second stream.

22. The method of claim 17,
wherein the second stream does not use the header compression of the given type, and
wherein the delay disparity between the first and second delays is indicative of whether the header compression of the given type is used for the first stream.

23. The method of claim 17, wherein the header compression of the given type is Robust Header Compression (RoHC).

24. The method of claim 17,
wherein the received information indicates the first and second delays, or
wherein the received information indicates the delay disparity, or
wherein the received information includes an explicit indication of whether the header compression of the given type is used for the first stream.

25. The method of claim 17, wherein the selectively modifying modifies one or more of a transcoding scheme used by the first stream, a macroblock ordering scheme used by the first stream, an image, video or audio resolution used by the first stream, a bandwidth or bit-rate used by the first stream, a bundling factor of the first stream, whether a forward error correction mechanism is used by the first stream and/or a type or degree of forward error correction mechanism used by the first stream.

26. The method of claim 25,
wherein the selectively modifying modifies the transcoding scheme to include a higher data budget at a source encoding level if the header compression of the given type is determined to be used, and
wherein the selectively modifying does not modify the transcoding scheme to include the higher data budget at the source encoding level if the header compression of the given type is determined not to be used.

27. The method of claim 25,
wherein the selectively modifying maintains the bundling factor at a higher bundling level or increases the bundling factor to the higher bundling level if the header compression of the given type is determined to be used, and
wherein the selectively modifying maintains the bundling factor at a lower bundling level or decreases the bundling factor to the lower bundling level if the header compression of the given type is determined not to be used.

28. The method of claim 17,
wherein the target device is a server mediating the given communication session between the source client device and a target client device, or
wherein the apparatus is the target client device.

29. An apparatus, comprising:
logic configured to receive a first stream and a second stream for a given communication session that originates from an application-layer client application on a source client device;
logic configured to calculate a first delay of arrival times for packet payload portions within the first stream;
logic configured to calculate a second delay of arrival times for packet payload portions within the second stream; and
logic configured to report information that is indicative of a delay disparity between the first and second delays to the application-layer client application on the source client device.

30. A source client device configured to execute an application-layer client application, comprising:
logic configured to transmit a first stream and a second stream for a given communication session to a target device;
logic configured to receive information that is indicative of, as calculated at the target device, a first delay of arrival times for packet payload portions within the first stream and a second delay of arrival times for packet payload portions within the second stream;
logic configured to determine whether header compression of a given type is used for the first stream based on the received information; and
logic configured to selectively modify one or more parameters of the first stream based on the determination.
